(19) United States
(12) Patent Application Publication
(10) Pub. No.: US 2007/0081361 A1
(43) Pub. Date: Apr. 12, 2007

(54) Light emitting diode backlight for liquid crystal displays

(76) Inventor: Donald Clary, Rancho Palos, CA (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/546,966

(22) Filed: Oct. 12, 2006

Related U.S. Application Data
(60) Provisional application No. 60/725,952, filed on Oct. 12, 2005.

(51) Int. Cl. F21V 7/04

(52) U.S. Cl. 362/624; 362/612

(57) ABSTRACT

The invention is directed to a backlight for a display which utilizes a light emitting diode array as a light source and is devoid a light guide.

### FIELD OF THE INVENTION

This invention relates to a backlight and its use in a display. More specifically it relates to a backlight that utilizes a light emitting diode (LED) array as a light source and is devoid of a light guide.

### BACKGROUND OF THE INVENTION

Liquid-crystal displays (LCD) provided with a backlighting system that is thin and which allows for easy viewing of information on a screen are used with recent models of word processors or computers. One backlighting mechanism, as shown in FIG. 1, in common use adopts an “edge lighting” method in which a linear light source (101) such as a fluorescent tube is provided in proximity to one end portion of a transmissive light conducting plate or light guide (102). The purpose of the light guide in a liquid crystal display backlight is to bring in light from the side, bend it by approximately 90°, and distribute the light uniformly across the rear surface of an LCD.

Another backlighting mechanism, as shown in FIG. 2, is in common use and places the light source or sources 201, such as an array of light emitting diodes (LEDs), directly behind the LCD. Diffusers 202 scatter light. This type of backlight is called a direct view backlight, since the observer views the light source directly through the LCD.

Another approach uses what is called a mixing chamber as shown in FIG. 3 (for mixing the red, green and blue primary colors into white light). Mixing chambers are often long and sometimes folded. Folded mixing chambers usually direct the light into a conventional light guide.

There is a need in the industry for a backlight device utilizing LEDs having a simplified configuration. The present invention fulfills that need.

### SUMMARY OF THE INVENTION

In one embodiment, the invention is directed to a device for a display having a bottom surface opposing an open top, opposing first and second sides; and opposing third and fourth sides, wherein the opposing first, second, third and fourth sides independently make an angle found within the range of about 80° to 100° and includes all values found therein with the bottom surface and wherein the open top connects to the display, a first plurality of light sources disposed on the first side and a second plurality of light sources disposed on the second side, having a diffuse reflector material disposed on the bottom surface, and the diffuse reflector material having a plurality of specular reflection material disposed thereon.

In another embodiment, the invention is directed to a device for a display having a bottom surface opposing an open top, opposing first and second sides, opposing third and fourth sides, wherein the opposing first, second, third and fourth sides independently make an angle found within the range of about 80 ° to 100° and includes all values found therein with the bottom surface and wherein the open top connects to the display; a first plurality of light sources disposed on the first side and a second plurality of light sources disposed on the second side, having a diffuse reflector material disposed on the bottom surface wherein the diffuse reflector material is disposed between the first side and the second side and having a center being half length between the first side and the second side wherein the half length varies in a parabolic manner versus position from the center and the first side and the half length varies in a parabolic manner versus position from the center and the second side.

### BRIEF DESCRIPTION OF THE DRAWINGS

FIGS. 1-3 illustrate prior art backlight systems.

FIG. 4A illustrates a backlight device with LED arrays and heat sinks.

FIG. 4B illustrates a lighted side of the chamber of the device.

FIG. 5 illustrates a Zebra design.

FIG. 6 illustrates a parabolic design.

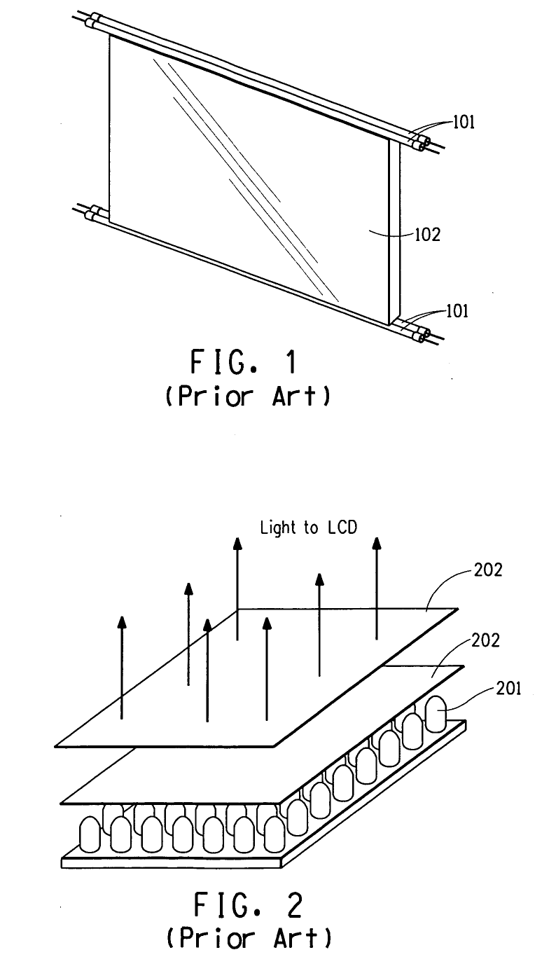

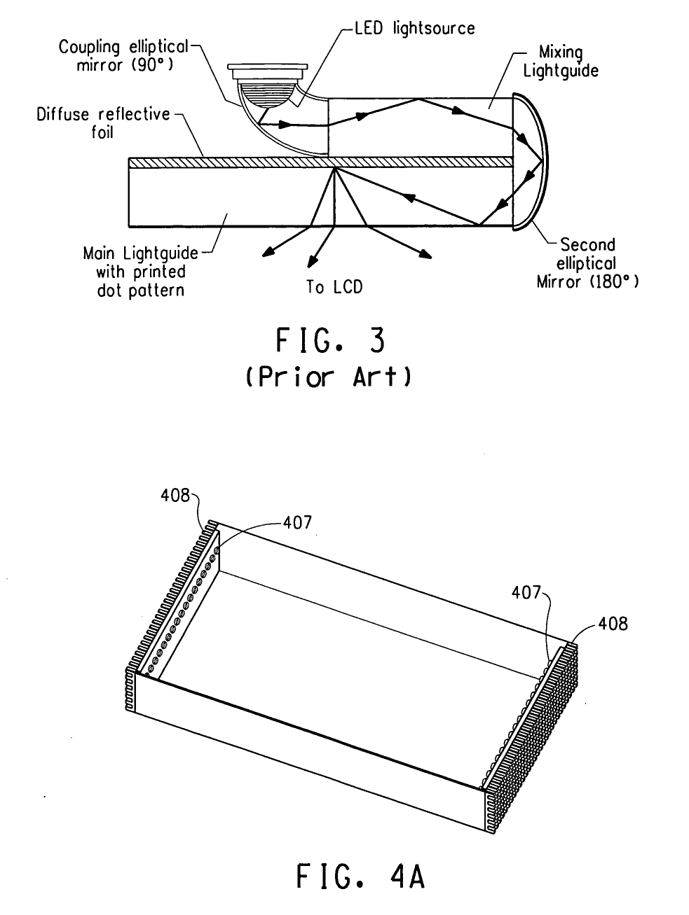

### DESCRIPTION OF THE INVENTION

The present invention relates to a backlighting device. The device brings in light from the side, does not use a light guide, and does not require a long length for mixing. It is noted that the angle, wherein the first, second, third and fourth side meet the bottom surface of the box, is found within the range of about 80° to 100° including all values found therein. The box forms a chamber to mix light emitted from an array of LEDs.

In an embodiment the LEDs are characterized to emit at least one color selected from red, green, and blue. In another embodiment the LEDs are characterized to emit red, green, and blue light. In yet another embodiment the LEDs are characterized to emit blue light and are coated with a yellow phosphor.

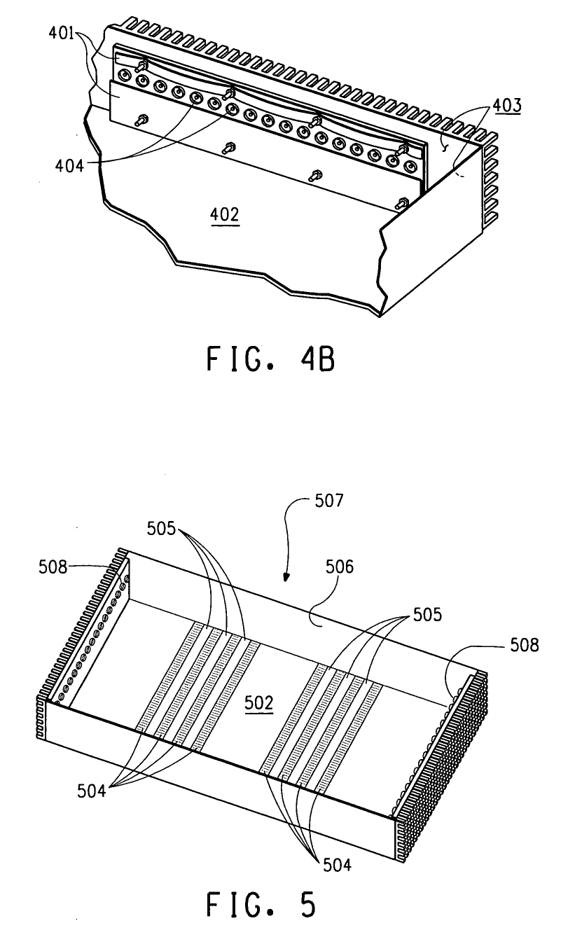

In the figures, it is understood that a LCD screen covers the top of the open side of the backlight device. FIG. 4A illustrates a backlight device with LED arrays 407 and heat sinks 408. The sides of the device make an angle with the bottom within the range of about 80° to 100°. Typically, 90° is optimum. In the embodiment, interior wires were run from the LEDs to the sides of the chamber and white reflectors was placed to cover the wires of the array. The sides and bottom were also covered with white reflectors. FIG. 4B is directed to a lighted side of the chamber. The LEDs 404 have black connectors that are covered with white reflectors 401. It was learned that the reflectors over the wires and reflectors over the connectors need to be at least substantially parallel to the sides and at least substantially perpendicular to the bottom to give a uniform light pattern. The rectangular walled design gives much better light uniformity than a design with slanted walls. The rectangular design of FIG. 4 exhibits a somewhat dimmer brightness in the center than near the LEDs at the ends. This could be corrected using a light guide but that would increase costs and reduce optical efficiency.

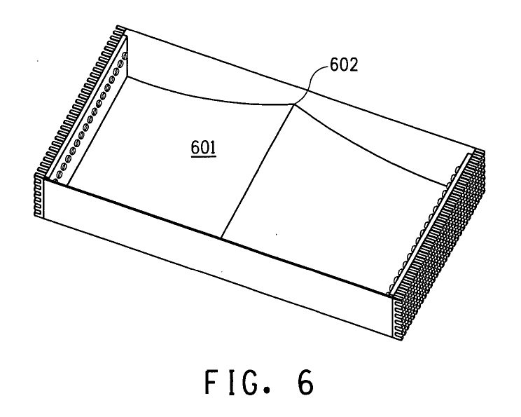

FIG. 5 illustrates an embodiment of the invention, termed a Zebra design. The backlight design relies on increased optical reflection. A rectangular chamber, as shown in FIG. 5 as 507, is lined on the bottom with a (e.g., Kimoto) diffuse white reflector 502, that reflects about 95% of the light. The diffuse reflection mixes the red, green and blue light (RGB). Specular reflectors 506 were placed on the four side walls, and the result was increased brightness but exhibited marginal color mixing. In an embodiment, added to the chamber was two 2″ wide silver 3M enhanced specular reflectors (ESR) (not shown in the figure) that reflect at 98% were placed on the bottom of the chamber. Since the light makes multiple bounces, about a 3% increase was achieved. The specular reflectors were placed approximately ¼ of the distance from each side between the two LED strips 508. This bounces the light into the center. Placing the silver specular reflectors at the center is not efficient, because the light is directed to the sides, which are already too bright from the LEDs located on the sides. An LCD is placed on top of the open box. The 2″ wide silver reflectors resulted in a visible sharp line on the LCD where the silver specular reflector ends and the white Kimoto reflector begins. In another embodiment, as shown in FIG. 5, visible sharp lines on the LCD were eliminated, multiple silver strips 504 about (¼″) wide were placed at the approximate ¼ distance position, with about equal ¼″ strips of diffuse white reflector 505 showing between the silver strips. The Zebra striping resulted in increased brightness in the center, showed no brightness lines, mixed the RGB light properly, and is low in cost to manufacture.

FIG. 6 illustrates another embodiment of the invention termed the Ski Jump. It is a parabolic design wherein the Kimoto white reflector 601 begins at the base of the LED lights and is closest to the LCD at the center 602 of the chamber. The center usually exhibits the dimmest lighting. The Kimoto white reflector is continuous from the sides that house the LED arrays. The reflector is farther away from the LCD at the ends, where the LED array is the brightest. The slope of the parabolic design and the height of the slope at the center may be adjusted. For example, the brightness at the LCD center can be adjusted by raising or lowering the height at the center. The curve may be a smooth curve. The parabolic curve as shown in FIG. 6 could be changed to a simple wedge design. It is believed that this change from parabolic to a wedge shape could be made without a loss of optical uniformity.

The display embodiment shown in FIG. 4A produced a luminance of 700 cd/m2 in test trials. The Zebra (FIG. 5) and the Ski Jump (FIG. 6) embodiments were found to increase luminance to about 800/cdm2, while significantly improving uniformity of light and color.

Although the materials used herein are standard in the industry, specific materials that may be used are listed below. White reflector material is Kimoto RW188 from Kimoto LTD, Switzerland. Silver reflector material is Kimoto GR38W from Kimoto LTD, Switzerland. LEDs are Lumiled Luxeon DCC strips, model #MGBA from Philips Lighting Company, CA, USA.

What is claimed is:

1. A device for a display comprising:
a. a bottom surface opposing an open top;
b. opposing first and second sides;
c. opposing third and fourth sides;
wherein the opposing first, second, third and fourth sides independently make an angle found within the range of about 80° to 100° with the bottom surface and wherein the open top connects to the display;
a first plurality of light sources disposed on the first side and a second plurality of light sources disposed on the second side;
having a diffuse reflector material disposed on the bottom surface; and the diffuse reflector material having a plurality of specular reflection material disposed thereon.

2. The device of claim 1 wherein the specular reflective material having a first plurality of strips parallel or nearly parallel to the first plurality of light sources and having a second plurality of strips that are parallel or nearly parallel to the second plurality of light sources.

3. The device of claim 2 wherein the first plurality of strips and the second plurality of strips are disposed on the bottom surface about one-fourth of distance from the respective light source.

4. The device of claim 1 wherein the first, second, third and fourth sides each makes an angle of about 90° with the bottom surface.

5. The device of claim 1 wherein the first plurality of light sources and the second plurality of light sources are light emitting diodes (LEDs).

6. The device of claim 5 wherein the light emitting diodes are characterized to emit at least one color selected from the group consisting of red, green, and blue.

7. The device of claim 5 wherein the light emitting diodes are characterized to emit red, green, and blue light.

8. The device of claim 5 wherein the light emitting diodes are characterized to emit blue light and are coated with a yellow phosphor.

9. A device for a display comprising:
a. a bottom surface opposing an open top;
b. opposing first and second sides;
c. opposing third and fourth sides;
wherein the opposing first, second, third and fourth sides independently make an angle found within the range of about 80°to 100° and includes all values found therein with the bottom surface and wherein the open top connects to the display;
a first plurality of light sources disposed on the first side and a second plurality of light sources disposed on the second side;
having a diffuse reflector material disposed on the bottom surface wherein the diffuse reflector material is disposed between the first side and the second side and having a center being half length between the first side and the second side wherein the half length varies in a parabolic manner versus position from the center and the first side and the half length varies in a parabolic manner versus position from the center and the second side.

10. The device of claim 9 wherein placement of the diffuse white reflector within the device is done such that distance between the white reflector and the open top is greatest at one or both members of a set of opposing sides bearing the first and second pluralities of light sources.

11. The device of claim 9 wherein the first, second, third and fourth sides each makes an angle of about 90° with the bottom surface and are perpendicular with the bottom surface.

12. The device of claim 9 wherein the first plurality of light sources and the second plurality of light sources are light emitting diodes (LEDs).

13. The device of claim 12 wherein the light emitting diodes are characterized to emit at least one color selected from the group consisting of red, green, and blue.

14. The device of claim 12 wherein the light emitting diodes are characterized to emit red, green, and blue light.

15. The device of claim 12 wherein the light emitting diodes are characterized to emit blue light and are coated with a yellow phosphor.
